(19) United States
(12) Patent Application Publication
(10) Pub. No.: US 2006/0215251 A1
(43) Pub. Date: Sep. 28, 2006

(54) Display element

(75) Inventors: Hiroaki Moriyama, Kanagawa (JP); Yasuo Yamamoto, Kanagawa (JP); Takayuki Takeuchi, Kanagawa (JP); Rie Ishii, Kanagawa (JP); Jun Kawahara, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/202,517

(22) Filed: Aug. 12, 2005

(30) Foreign Application Priority Data
Mar. 25, 2005 (JP) 2005-90264

(51) Int. Cl. G02B 26/00

(52) U.S. Cl. 359/296

(57) ABSTRACT

The present invention provides a display element including a first electrode, a second electrode, and a light-modulating layer containing transportable charged fine particles showing coloration in a dispersion state. Also, the present invention provides a display element including a plurality of light-modulating unit cells, the unit cells each including a first electrode, a second electrode, and a light-modulating layer containing transportable charged fine particles showing coloration in a dispersion state, wherein the unit cells are layered such that light-modulating faces of the light-modulating layers are overlaid on each other.

### CROSS-REFERENCE TO RELATED APPLICATION

This application claims priority under 35 USC 119 from Japanese Patent Application No. 2005-90264, the disclosure of which is incorporated by reference herein.

### BACKGROUND OF THE INVENTION

1. Field of the Invention

The present invention relates to an optical element using transportable charged fine particles widely usable as optical elements such as light-modulating glass, a light-modulating element, and a display element. In particular, the invention relates to an optical element using metal colloid, which can reversely change color by an electric field, regulate the quantity of light transmission and light reflection in a wide range of wavelength, show various color tones, and display various patterns.

2. Description of the Related Art

Along with the advancement of the highly information-based society, needs of electronic paper systems, color display systems, and large surface area display systems have been increased. As technologies to realize these systems, display technologies such as CRT, liquid crystal, EL, LED, and plasma have been developed. Further, besides these self-light-emitting systems, developments of reflection type display systems, which can save electric power consumption and scarcely cause an uncomfortable feeling to eyes of human being, have been investigated. As the reflection type display system, a reflection type liquid crystal technique is dominantly used.

On the other hand, while needs for the next generation of electronic paper display systems are very high, the present situation is that hopeful techniques to satisfy the needs have not established yet. As candidate methods supposed to be practically usable, an electrophoresis method, a liquid crystal method, and an organic EL method have been known.

Since a liquid crystal method is a filter method, it has a problem that the medium thickness and weight are difficult to decrease. Since an organic EL method is a self-light-emitting type, there is a problem that it has no memory and its uses are thus limited within a narrow range.

As a display element using an electrophoresis method, the following techniques have been disclosed.

A method of using microcapsules arranged between a pair of electrodes, wherein a dispersion media and electrophoresis particles are encapsulated in the microcapsules, has been disclosed (e.g., refer to Japanese Patent Application Laid-Open (JP-A) No. 64-86116). Also, a magnetophoresis method using microcapsules encapsulating a magnetic fluid has been reported (e.g., refer to JP-A No. 4-199085).

Further, a method of selectively driving plural kinds of colored particles disposed in a mixed state in a single microcapsule has been disclosed (e.g., refer to U.S. Pat. No. 6,017,584).

However, since all of these methods use microcapsules, it is difficult to carry out fine dot display and full color display. In the case of the method disclosed in JP-A No. 64-86116, since the colors displayed simultaneously are only two colors, it is difficult to give full color display. Further, the method described in U.S. Pat. No. 6,017,584 has difficulty in selectively driving the particles in principle.

Further, a structure has been described in which approximately the same amount of charged electrophoresis particles are each disposed in a plurality of sections divided along the surfaces of a pair of substrates having a prescribed distance therebetween, and the dispersion medium is blue and the electrophoresis particles are black. It has been reported that the display quality can be improved by the structure (e.g., refer to JP-A No. 2000-322,004).

However, the structure has difficulty in full color display, and must have a parallel arrangement because if layered, color display by a subtractive color-mixing method using combination of particles in the respective layers cannot be carried out. As a result, the apparatus becomes complicated.

Further, a method for carrying out color display by arranging the cells or microcapsules expressing a plurality of colors in parallel has been disclosed (e.g., refer to JP-A No. 2000-35598). In this method, owing to the parallel arrangement, high resolution and sufficient contrast cannot be achieved.

Further, a method of layering two or more layers of light transmitting electrophoresis parts containing particles and/or a medium in vertical direction has been disclosed (e.g., refer to JP-A No. 2002-333643). However, dyes are used for coloring the particles and therefore no sufficient coloration density is obtained.

A method of forming a plurality of storage parts for housing electrophoresed fine particles has been disclosed (e.g., refer to JP-A No. 2002-162649). However, in the case of color display, since particles with different colors have to be arranged in parallel, color regeneration property and high contrast cannot be obtained.

Further, a method has been disclosed wherein the cells having two display electrodes arranged at overlaying positions, two collection electrodes, and two kinds of light transmitting colored particles are layered or parallel arranged (e.g., refer to JP-A No. 2004-20818). However, since relatively large particles colored by dyes are employed, no sufficient color density can be obtained and stability of the coloring agents are problematic.

As described above, even in electrophoresis methods, there still remain problems of simultaneously satisfying high resolution, high reflectance, and coloration, and methods of solving the problems have been desired in the present situation.

### SUMMARY OF THE INVENTION

The present invention has been made in view of the above circumstances and provides an excellent display element having high resolution and capability of full-color display.

A first aspect of the invention provides a display element comprising a first electrode, a second electrode, and a light-modulating layer containing transportable charged fine particles showing coloration in a dispersion state.

A second aspect of the invention provides a display element comprising a plurality of light-modulating unit cells, the unit cells each comprising a first electrode, a second electrode, and a light-modulating layer containing transportable charged fine particles showing coloration in a dispersion state, wherein the unit cells are layered such that light-modulating faces of the light-modulating layers are overlaid on each other.

### BRIEF DESCRIPTION OF THE DRAWINGS

Embodiments of the present invention will be described in detail based on the following figures, wherein:

FIG. 1A to 1D shows a schematic view of a display element produced in Example 1, one embodiment of a display element of the invention;

FIG. 2A to 2C shows a schematic view of a display element produced in Example 2, another embodiment of a display element of the invention;

FIG. 3A to 3C shows a schematic view of a display element produced in Example 3, another embodiment of a display element of the invention; and

FIG. 4A to 4D shows a schematic view of a display element produced in Example 5, further another embodiment of a display element of the invention.

### DETAILED DESCRIPTION OF THE INVENTION

Hereinafter, the present invention will be described in more detail.

<Display Element>

A display element of the invention is provided with a first electrode, a second electrode, and a light-modulating layer containing transportable charged fine particles showing coloration in dispersion state.

Owing to the structure including the above-mentioned pair of electrodes and light-modulating layer containing transportable charged fine particles for coloration, the display element of the invention has high resolution and is capable of giving full color display.

The display element of the invention may further be provided with a voltage applicator to the electrodes. The voltage applicator is not particularly limited as long as it can apply DC voltage and AC voltage.

(Light-Modulating Layer)

The light-modulating layer of the invention contains transportable charged fine particles showing coloration in dispersion state. The layer may further contain an insulating liquid, a polymer resin, a high molecular weight pigment dispersant and the like based on the necessity.

The above phrase “showing coloration in dispersion state” means showing hue observable with eye in the state that the transportable charged fine particles are dispersed in a medium.

The hue can be various colors by changing the transportable charged fine particles, especially the metal, shape, and particle diameter (volume average particle diameter) of metal colloidal particles.

The coloration by metal colloid such as gold colloid is attributed to plasma vibration of electrons and is caused by coloration mechanism so-called plasmon absorption. It is said that the coloration by the plasmon absorption is attributed to that free electrons in the metal are swung by photoelectric field; charge appears on the surface of the particles; and non-linear polarization is thus caused. The coloration by the metal colloid has high chromaticity and light transmittance, and is excellent in durability. Such coloration by the metal colloid can be observed when the particles are so-called nano-particles with a particle diameter of several nm to several tens nm, and colloids with a narrow particle diameter distribution are advantageous as a coloring material.

—Transportable Charged Fine Particles—

The transportable charged fine particles are required to be fine particles showing coloration in the dispersion state and having transportability by electric field (voltage) application, but they have no particular limitation other than that limitation. In terms of coloration and stability, metal colloidal particles having plasmon coloration function are preferable. Hereinafter, examples of the metal colloidal particles will be described, however the particles should not be limited to these examples.

Examples of metals of the metal colloidal particles are noble metals and copper (hereinafter, all together, referred to as metal). Examples of the noble metals are not particularly limited and may be gold, silver, ruthenium, rhodium, palladium, osmium, iridium, and platinum. Among them, gold, silver, and platinum are preferable.

Methods for obtaining the metal colloidal particles have been known, such as: a chemical method of reducing metal ions and then preparing nano-particles via metal atoms and metal clusters; and a physical method of trapping metals in the form of fine particles generated by evaporation of a bulk metal in an inert gas using a cold trap, or a physical method of forming a metal thin film on a polymer thin film by vacuum evaporation, then breaking the metal thin film by heating, and successively dispersing the metal fine particles in a polymer in solid-phase state. The chemical method does not require any special apparatus and is thus advantageous for preparation of metal colloidal particles of the invention, and common examples thereof will be described later. However, the methods should not be limited to the exemplified methods.

The metal colloidal particles are formed from a compound of the above-mentioned metal. The compound of the metal is not particularly limited as long as it contains the metal and may be chloroauric acid, silver nitrate, silver acetate, silver perchlorate, chloroplatinic acid, potassium chloroplatinate, cupric chloride, cupric acetate, and cupric sulfate.

The metal colloidal particles can be obtained in the form of a dispersion liquid of metal colloidal particles protected with a dispersant by reducing the above-mentioned metal compounds dissolved in a solvent to metals, and may also be obtained in the form of a solid sol by further removing the solvent of the dispersion liquid. The metal colloidal particles can be obtained in any other form than these forms, too. At the time of dissolving the metal compounds, a high molecular weight pigment dispersant, which will be described later, may be used. Use of the high molecular weight pigment dispersant makes it possible to obtain stable metal colloidal particles protected by the dispersant.

When using the metal colloidal particles in the invention, the above-mentioned metal colloidal particles having the form of a dispersion liquid or that obtained by re-dispersing the above-mentioned metal colloidal particles having the form of a solid sol in a solvent can be used. The form of the metal colloidal particles to be used is not particularly limited.

When using the metal colloidal particles having the form of a dispersion liquid, as the solvent to be used in the preparation, insulating liquids described below are preferable. Further, when using the solid sol for being re-dispersed, as the solvent to be used for preparing the solid sol, any solvent can be used without any particular limitation. As the solvent to be used in the re-dispersion, insulating liquids described below are preferable.

The volume average particle diameter of the transportable charged fine particles is preferably 1 to 100 nm and more preferably 5 to 50 nm.

The metal colloidal particles can be colored in various colors based on the type, shape, and volume average particle diameter of the metal. Therefore, use of the transportable charged fine particles with controlled type, shape, and volume average particle diameter of the metal makes it possible to give various hues including RGB coloration, and makes the display element of the invention be a color display element. Further, control of the shape and particle diameter of the metal and the metal colloidal particles to be obtained makes it possible to give an RGB full color-type display element.

The volume average particle diameter of the metal colloidal particles for showing the respective colors of R, G, and B in the RGB system cannot be specifically limited since it depends on the metal, the particle preparation condition, and the shape. For example, in the case of gold colloidal particles, as the volume average particle diameter becomes larger, the color tends to change from R coloration to G coloration, and further to B coloration

As the measurement method of the volume average particle diameter in the invention, a laser diffraction scattering method of radiating laser beam to particles and measuring the average particle diameter from the intensity distribution pattern of the diffracted and scattered light from the particles can be employed.

The content (% by weight) of the transportable charged fine particles in the total weight of the light-modulating layer is not particularly limited as long as the concentration is such that a desired hue can be obtained. It is effective for the display element to adjust the content in accordance with the thickness of the light-modulating layer. That is, to obtain a desired hue, the content is adjusted to be low when the light-modulating layer is thick, and the content is adjusted to be high when the light-modulating layer is thin. Generally, it is 0.01 to 50% by weight.

The above-mentioned metal colloidal particles may be prepared by common preparation methods described, for example, in “Synthesis and Preparation of Metal Nano-Particles, Control Techniques and Application Developments”, Technical Information Institute Co., Ltd., 2004. Hereinafter, one example will be described, however, the method should not be limited to the exemplified method.

—Solid Sol—

Hereinafter, one example of a solid sol of a metal in the preparation of the metal colloidal particles as mentioned above will be described.

In the solid sol of a metal in the invention, in terms of the coloration, the above-mentioned metal colloidal particles are preferably contained in an amount of 50 mmol or more per 1 kg of the high molecular weight pigment dispersant, which will be described later. If the amount of the metal colloidal particles is less than 50 mmol, the coloration becomes insufficient. It is more preferably 100 mmol or more.

With respect to the solid sol of a metal in the invention, the metal colloidal particles preferably have a volume average particle diameter of 1 to 100 nm. If it is smaller than 1 nm, the coloring strength is low, and if it exceeds 100 nm, the chroma will be low. Further, the solid sol of a metal in the invention preferably has a narrow particle size distribution. If the particle size distribution is wide, the chroma will be low, and therefore it is undesirable.

Since the solid sol of a metal of the invention has high chroma and contains the metal colloidal particles in a high concentration, the coloration is good. The metal solid sol of the invention has good compatibility with a polymer resin (binder) such as a resin. Therefore, when the metal solid sol is added to such a polymer resin (binder), it is stable and is not agglomerated and has sufficient coloring strength. Based on the necessity, other additives may be added. Further, the metal solid sol may be dissolved in a proper solvent and be used in the form of a hydrosol or organosol.

—Production Method of Solid Sol—

Hereinafter, one example of a production method of the above-mentioned metal solid sol will be described, however, the method should not be limited to the exemplified method. A metal compound is dissolved in a solvent, mixed with a high molecular weight pigment dispersant, and then reduced to metal, thereby forming metal colloidal particles protected with the high molecular weight pigment dispersant. After that, the solvent is removed to obtain a solid sol.

In the production method, the above-mentioned metal compound may be used after being dissolved in a solvent. The solvent is not particularly limited as long as it can dissolve the metal compound. Examples of the solvent may be water and water-soluble organic solvents such as acetone, methanol, and ethylene glycol. They may be used alone or in combination of two or more. In the invention, water and a water-soluble organic solvent are preferably used in combination.

When the above-mentioned solvent is a mixed solvent of water and a water-soluble organic solvent, it is preferable that at first, the above-mentioned metal compound is dissolved in water and then the water-soluble organic solvent is added thereto for obtaining the solution. In this case, the metal compound is preferably dissolved in water in a concentration of 50 mM or higher. If the concentration is lower than 50 mM, it is impossible to obtain a solid sol containing metal colloidal particles in a high ratio. The concentration is more preferably 100 mM or higher.

When using silver as a metal, the above-mentioned aqueous solution is preferably at pH 7 or lower. If the pH exceeds 7, for example, when using silver nitrate as the silver compound, a byproduct such as silver oxide will be produced at the time of reducing silver ion. As a result, the solution becomes cloudy and therefore it is undesirable. If the pH of the above-mentioned aqueous solution exceeds 7, it is preferable to adjust the pH to be 7 or lower by adding, for example, about 0.1N of nitric acid.

The volume ratio of the above-mentioned water-soluble organic solvent to water for dissolving the metal compound is preferably 1.0 or higher. If it is less than 1.0, a water-insoluble high molecular weight pigment dispersant cannot be dissolved. It is preferably 5.0 or higher.

In the preparation of the metal colloidal particles of the invention, it is also effective to add the high molecular weight pigment dispersant to a solution of the above-mentioned metal compound. The high molecular weight pigment dispersant is preferably water-insoluble in the case where the solvent is a mixed solvent of water and a water-soluble organic solvent. If the dispersant is water-soluble, at the time of obtaining a solid sol by removing the water-soluble organic solvent, it becomes difficult to precipitate the colloidal particles. As the water-insoluble high molecular weight pigment dispersant, examples may be Disperbyk 161 and Disperbyk 166 (manufactured by Byk Mallinckrodt International Corporation,) and Solsperse 24000 and Solsperse 28000 (manufactured by Zeneca K.K.).

The addition amount of the high molecular weight pigment dispersant is preferably 20 to 1000 parts by weight based on 100 parts by weight of the above-mentioned metal. If it is lower than 20 parts by weight, the dispersibility of the metal colloidal particles is insufficient, If it exceeds 1,000 parts by weight, in the case the high molecular weight pigment dispersant is blended to a coating material or a resin molded substance, the mixed amount of the high molecular weight pigment dispersant may become so large as to cause adverse effects on the physical properties. It is more preferably 50 to 650 parts by weight.

In the preparation of metal colloidal particles in the invention, after the high molecular weight pigment dispersant is added to the above-mentioned metal compound solution, the metal ion is reduced. The reduction method is not particularly limited. Examples thereof include a method of carrying out chemical reduction by adding a compound and a method of carrying out reduction by light radiation using a high pressure mercury lamp.

The above-mentioned compound to be added is not particularly limited, and for example, alkali metal boron hydrides such as sodium boron hydride; hydrazine compounds; citric acid or its salts, succinic acid and its salts, which are conventionally used as reducing agents, can be used. In the invention, besides the above-mentioned reducing agents, amines can be used.

The above-mentioned amines can reduce the metal ion to the metal at around normal temperature by adding the amines to the metal compound solution and stirring and mixing the resulting solution. Use of the amines makes it unnecessary to use a risky or harmful reducing agent and makes reduction of the metal compound possible at a temperature of about 5 to 100° C., preferably 20 to 80° C. without heating and a special light radiation apparatus.

The above-mentioned amines are not particularly limited and examples may include aliphatic amines such as propylamine, butylamine, hexylamine, diethylamine, dipropylamine, dimethylethylamine, diethylmethylamine, triethylamine, ethylenediamine, N,N,N′,N′-tetramethylethylenediamine, 1,3-diaminopropane, N,N,N′,N′-tetramethyl-1,3-diaminopropane, triethylenetetramine and tetraethylenepentamine; alicyclic amines such as piperidine, N-methylpiperidine, piperazine, N,N′-dimethylpiperazine, pyrrolidine, N-methylpyrrolidine, and morpholine; aromatic amines such as aniline, N-methylaniline, N,N-dimethylaniline, toluidine, anisidine, and phenetidine; and aralkylamines such as benzylamine, N-methylbenzylamine, N,N-dimethylbenzylamine, phenethylamine, xylylenediamine, N,N,N′,N′-tetramethylxylylenediamine. Also, as the above-mentioned amines, alkanolamines such as methylaminoethanol, diethylaminoethanol, triethanolamine, ethanolamine, diethanolamine, methyldiethanolamine, propanolamine, 2-(3-aminopropylamino)ethanol, butanolamine, hexanolamine, and dimethylaminopropanol can be exemplified. Among them, alkanolamines are preferable.

The addition amount of the above-mentioned amines is preferably 1 to 50 mol based on 1 mole of the above-mentioned metal compound. If it is less than 1 mole, reduction cannot be carried out sufficiently, and if it exceeds 50 mol, the stability against agglomeration of the produced colloidal particles may be deteriorated. It is more preferably 2 to 8 mol.

When using the above-mentioned sodium boron hydride as the reducing agent, since reduction can be carried out at a normal temperature, there is no need to carry out heating or use any special light radiating apparatus.

The addition amount of sodium boron hydride is preferably 1 to 50 mol based on 1 mole of the above-mentioned metal compound. If it is less than 1 mole, reduction cannot be carried out sufficiently, and if it exceeds 50 mol, the stability against agglomeration of the produced colloidal particles may be deteriorated. It is more preferably 1.5 to 10 mol.

When citric acid or its salts are used as the reducing agent, the metal ion can be reduced by heating and refluxing the mixture in the presence of an alcohol. As citric acid or its salts, sodium citrate is preferably used.

The addition amount of the citric acid or its salts is preferably 1 to 50 mol based on 1 mole of the above-mentioned metal compound. If it is less than 1 mole, reduction cannot be carried out sufficiently and if it exceeds 50 mol, the stability against agglomeration of the produced colloidal particles may be deteriorated. It is more preferably 1.5 to 10 mol.

In the preparation of the metal colloidal particles in the invention, after the metal ion is reduced, the metal colloidal particles protected with the above-mentioned high molecular weight pigment dispersant are precipitated and then the above-mentioned solvent is removed. In the case that as the solvent, water and a water-soluble organic solvent are used, the solvent can be removed according to the following method in accordance to the characteristics of the high molecular weight pigment dispersant to be used.

In the case the above-mentioned high molecular weight pigment dispersant is water-insoluble, it is preferable that the water-soluble organic solvent is at first removed by evaporation or the like and after the metal colloidal particles protected with the high molecular weight pigment dispersant are precipitated, water is removed. Since the high molecular weight pigment dispersant is water-insoluble, removal of the above-mentioned water-soluble organic solvent promotes precipitation of the metal colloidal particles protected with the high molecular weight pigment dispersant.

In this case, the above-mentioned water-soluble organic solvent preferably has a higher evaporation speed than that of water. If the evaporation speed is lower than that of water, when a water-insoluble dispersant is used as the above-mentioned high molecular weight pigment dispersant, the above-mentioned water-soluble organic solvent cannot be removed prior to removing water and thus the metal colloidal particles cannot be precipitated for obtaining the solid sol by removing the solvent.

In the case the high molecular weight pigment dispersant is a solvent type, an excess amount of a non-polar organic solvent which does not dissolve the high molecular weight pigment dispersant can be added to precipitate the metal colloidal particles protected by the high molecular weight pigment dispersant and then the solvent can be removed by decantation or so.

The metal colloidal particles protected with the high molecular weight pigment dispersant may be washed with ion-exchanged water after the solvent removal. In the case the metal colloidal particles protected with the high molecular weight pigment dispersant are precipitated by addition of an excess amount of the above-mentioned non-polar solvent, the colloidal particles can be washed with the non-polar solvent.

In the production method of the metal solid sol of the invention, the obtained metal solid sol has a colloid average particle diameter of 1 to 100 nm and a narrow particle size distribution, so that the solid sol has a high density color and high chromaticity.

The production method of the metal solid sol of the invention can be carried out simply in a small number of the steps of dissolving the above-mentioned metal compound in a solvent to obtain a solution, adding the above-mentioned high molecular weight pigment dispersant, reducing the metal compound to the metal, and thereafter removing the solvent. Moreover, the method can produce a metal solid sol having increased chromaticity, which contains metal colloidal particles in a high concentration as compared with conventional metal colloidal particles. Especially, use of an alkanolamine makes the production easy under moderated conditions of about 20 to 80° C.

The metal colloidal particles can be prepared by the above-mentioned manner, and as the metal colloidal particles in the invention, commercialized metal colloidal particles may be used, as long as the colloidal particles show coloration in dispersion state.

Further, the metal colloidal particles can be prepared practically by the following methods (1) to (4), however it should not be limited to these preparation methods.

Preparation Method of Dispersion Liquid of Metal Colloidal Particles—

As a preparation method of a dispersion liquid of the metal colloidal particles in the invention, both water-based and non-polar solvent-based dispersion liquids can be prepared. For example, in the case of a metal colloidal particle dispersion liquid using, for example, gold and silver, the dispersion liquid can be prepared by the following production methods, however it should not be limited to the following production methods.
(1) After a metal compound (e.g. tetrachloroauric (III) acid tetrahydrate) is dissolved in an insulating liquid (e.g. water), a solution containing a high molecular weight pigment dispersant (e.g. Soisperse 20000) in a weight amount 1.5 times as much as that of the metal (e.g. gold) is added and stirred.

After an aliphatic amine (e.g. dimethylaminoethanol) is added to the mixed solution to start reduction of gold ion, filtration and concentration is carried out to obtain a gold colloidal particle solution.
(2) After a metal compound (e.g. tetrachloroauric (III) acid tetrahydrate) is dissolved in water, a solution obtained by dissolving a high molecular weight pigment dispersant (e.g. Solsperse 24000) in a weight amount 1.5 times as much as that of the metal (e.g. gold) in a non-polar organic solvent (e.g. acetone) is added and stirred.

After an aliphatic amine (e.g. dimethylaminoethanol) is added to the mixed solution to start reduction of gold ion, the non-polar solvent is evaporated to obtain solid sol containing gold colloidal particles and high molecular weight pigment dispersant. After that the solid sol is washed with water by decantation and dissolved in a non-polar organic solvent (e.g. ethanol) to obtain a gold colloidal particle solution.
(3) After a metal compound (e.g. silver nitrate (I)) is dissolved in water, an aqueous solution containing a high molecular weight pigment dispersant (e.g. Solsperse 20000) in a weight amount 1.5 times as much as that of the metal (e.g. silver) is added and stirred. After an aliphatic amine (e.g. dimethylaminoethanol) is added to the mixed solution to start reduction of silver ion, filtration and concentration is carried out to obtain a water-based silver colloidal particle solution.
(4) After a metal compound (e.g. silver (I) nitrate) is dissolved in water, a solution obtained by dissolving a high molecular weight pigment dispersant (e.g. Solsperse 24000) in a weight amount 1.5 times as much as that of the metal (e.g. silver) in a non-polar organic solvent (e.g. acetone) is added and stirred. After an aliphatic amine (e.g. dimethylaminoethanol) is added to the mixed solution to start reduction of silver ion, the non-polar solvent is evaporated to obtain solid sol containing silver colloidal particles and high molecular weight pigment dispersant. After that the solid sol is washed with water by decantation and dissolved in a non-polar organic solvent (e.g. toluene) to obtain a solvent type silver colloidal particle solution.

With respect to the above-mentioned metal colloidal particles and their solutions, those described in JP-A No. 11-76800 can be preferably used.

—Insulating Liquid—

As a dispersion medium of the above-mentioned metal colloidal particles in the invention, insulating liquids are preferable.

Practically, preferable examples of the insulating liquids are hexane, cyclohexane, toluene, xylene, decane, hexadecane, kerosene, paraffin, isoparaffin, silicone oil, dichloroethylene, trichloroethylene, perchloroethylene, high-purity petroleum, ethylene glycol, alcohols, ethers, esters, dimethylformamide, dimethylacetamide, dimethyl sulfoxide, N-methylpyrrolidone, 2-pyrrolidone, N-methylformamide, acetonitrile, tetrahydrofuran, propylene carbonate, ethylene carbonate, benzine, diisopropylnaphthalene, olive oil, isopropanol, trichlorotrifluoroethane, tetrachloroethane, dibromotetrafluoroethane, and their mixtures.

Water (so-called pure water) may also be made preferably usable by removing impurities so as to give a volume resistance as described below. As the volume resistance, it is preferably 10³ Ωcm or higher, more preferably 10⁷ Ωcm to 10¹⁹ Ωcm, and even more preferably 10¹⁰ Ωcm to 10¹⁹ Ωcm. Adjustment of the volume resistance as described above suppresses bubble generated by electrolysis of the liquid attributed to electrode reaction and gives good repeating stability without deteriorating electrophoresis properties of the particles every time of electric power application.

The insulating liquids may be mixed with, based on necessity, an acid, an alkali, a salt, a dispersion stabilizer, a stabilizer for oxidation prevention and UV absorption, an anti-bacterial agent, and a preserver. These additives are preferably added in proper ranges so as to adjust the volume resistance in the above-specified range.

—Polymer Resin—

The above-mentioned transportable charged fine particles (metal colloidal particles) in the invention are also preferably dispersed in a polymer resin. As the polymer resin, polymer gel and network polymer are preferable.

Examples of the polymer resin are polymer gel derived from natural polymers such as agarose, agaropectin, amylose, sodium alginate, alginic acid propylene glycol ester, isolychnane, insulin, ethylcellulose, ethylhydoxyethylcellulose, cardrun, casein, carrageenan, carboxymethyl cellulose, carboxymethyl starch, callose, agar, chitin, chitosan, silk fibroin, guar gum, pyrus cydonia seed, crown gall polysaccharide, glycogen, glucomannan, keratan sulfate, keratin protein, collagen, cellulose acetate, gelan gum, schizophyllan, gelatin, vegetable ivory mannan, tunicine, dextran, dermatan sulfate, starch, gum tragacanth, nigeran, hyaluronic acid, hydroxyethyl cellulose, hydroxypropyl cellulose, pustulan, funoran, decomposed hydroxyglucan, pectin, porphyran, methyl cellulose, methyl starch, laminarane, lichenan, lentinan, and locust been gum, and are also almost all kinds of polymer gel in the case of synthetic polymers.

Further, examples include polymers containing functional groups such as alcohol, ketone, ether, ester, and amido in repeating unit. For example, polyvinyl alcohol, poly(meth)acrylamide and its derivatives, polyvinylpyrrolidone, polyethylene oxide and copolymers containing these polymers are also exemplified.

Among them, in terms of production stability and electrophoresis property, gelatin, polyvinyl alcohol, and poly(meth)acrylamide are preferably used.

These polymer resins are preferably used in combination with the above-mentioned insulating liquids.

High Molecular Weight Pigment Dispersant—

The above-mentioned high molecular weight pigment dispersant is not particularly limited and those descried below may be preferably used. That is:
(1) comb-teeth structure polymers having pigment-philic group in the main chain and/or a plurality of side chains and also having a plurality of side chains forming solvation portions;
(2) polymers having a plurality of pigment-philic portions comprising a pigment-philic group in the main chain; and (3) straight chain polymers having pigment-philic portions comprising a pigment-philic group in one terminal of the main chain.

Herein, the above-mentioned pigment-philic group means a functional group having a strong adsorptive power to the surface of a pigment and for example, in organo-sol, examples of such a functional group are tertiary amino group, quaternary ammonium, heterocyclic group having basic nitrogen atom, hydroxyl, and carboxyl; in hydrosol, examples of such a functional group are phenyl, lauryl, stearyl, dodecyl, and oleyl. In the invention, the pigment-philic group shows strong affinity to metals. Having the pigment-philic group, the above-mentioned high molecular weight pigment dispersant can exhibit sufficient capabilities as metal protection colloid.

The above-mentioned comb-teeth structure polymers (1) have a structure formed by bonding a plurality of side chains composing the solvation portions together with a plurality of side chains having the pigment-philic group to main chains, and these side chains are bonded to the main chains as if they form teeth of the comb-teeth structure. In this specification, the above-described structure is referred to as comb-teeth structure. With respect to the comb-teeth structure polymers (1), a plurality of pigment-philic groups may exist not only in side chain terminals but also in middle of side chains and main chains. The solvation portions are portions having affinity to a solvent and mean hydrophilic or hydrophobic structure. The solvation portions are composed of, for example, water-soluble polymer chains and oleophilic polymer chains.

The comb-teeth structure polymers (1) are not particularly limited and examples of the polymers are poly(ethylene imine) or its acid salts disclosed in JP-A No. 5-177123 and having one or more poly(carbonyl-C₃₋₆-alkyleneoxy) chains each of which has 3 to 80 carbonyl-C₃₋₆-alkyleneoxy chains and is bonded to the poly(ethylene imine) by amido or salt-crosslinking group; reaction products of poly(lower alkylene)imine and polyesters having free carboxylic acid groups disclosed in JP-A 54-37082 and having at least two polyester chains bonded to the respective poly(lower alkylene)imine chains; and pigment dispersants disclosed in Japanese Patent Application Publication (JP-B) No. 7-24746, which are obtained by reacting amine compounds and carboxyl-containing prepolymers having a number average molecular weight of 300 to 7,000 simultaneously or successively in optional order with high molecular weight epoxy compounds having epoxy group in the terminals.

The above-mentioned comb-teeth structure polymers (1) preferably have 2 to 3,000 pigment-philic groups per a molecule. If the number of the groups is less than 2, the dispersion stability is insufficient. If it exceeds 3,000, the viscosity becomes so high as to make handling difficult and also the particle size distribution of the colloidal particles becomes wide and the chromaticity is decreased. It is more preferably 25 to 1,500.

The comb-teeth structure polymers (1) preferably have 2 to 1,000 side chains composing the solvation portions per 1 molecule. If the number of the side chains is less than 2, the dispersion stability is insufficient. If it exceeds 1,000, the viscosity becomes so high as to make handling difficult and also the particle size distribution of the colloidal particles becomes wide and the chromaticity is decreased. It is more preferably 5 to 500.

The comb-teeth structure polymers (1) preferably have a number average molecular weight of 2,000 to 1,000,000. If the number average molecular weight is less than 2,000, the dispersion stability is insufficient. If it exceeds 1,000,000, the viscosity becomes so high as to make handling difficult and also the particle size distribution of the colloidal particles becomes wide and the chromaticity is decreased. It is more preferably 4,000 to 500,000.

With respect to the above-mentioned copolymers (2) having a plurality of pigment-philic portions comprising a pigment-philic group in the main chain, a plurality of the pigment-philic group is arranged along the main chain and the pigment-philic group is, for example, pendent wiht the main chain. In this specification, each pigment-philic portion comprises one or a plurality of the pigment-philic groups and works as an anchor for adsorption in the pigment surface.

Examples of the above-mentioned copolymers (2) are reaction products of mixtures of polyisocyanates with monohydroxy compounds and either monohydroxymonocarboxylic acids or monoaminomonocarboxylic acid compounds and compounds having at least one basic cyclic N group and isocyanate-reactive group as described in JP-A No. 4-210220; polymers wherein a plurality of tertiary amino groups or groups having basic heterocyclic nitrogen are pendants on polyurethane/polyurea main chains as described in JP-A Nos. 60-16631, 2-612, and 63-241018; copolymers comprising steric stabilized units having water-soluble poly (oxyalkylene) chains, structure units, and amino group-containing units, wherein the amino group-containing units contain tertiary amino groups or their acid adduct salt groups or quaternary ammonium groups and wherein 0.025 to 0.5 milli-eq. of amino-group is contained per 1 g of the copolymer, as described in JP-A No. 1-279919; amphipathic copolymers comprising addition polymerized main chains and stabilizer units comprising at least one C₁₋₄ alkoxypolyethylene or polyethylene-propylene glycol (meth) acrylate and having weight average molecular weight of 2,500 to 20,000, wherein the main chains contain not more than 30% by weight of non-flnctional structural unit and not more than 70% by weight of stabilizer units and the functional units in total, and wherein the functional units are (un)substituted styrene-containing units, hydroxyl-containing units, and carboxyl-containing units with the ratio of [1:(0.10 to 26.1)], [1:(0.28 to 25.0)], and [1:(0.80 to 66.1)] for (hydroxyl:carboxyl), (hydroxyl:styrene group), and (hydroxyl:propyleneoxy or ethylene oxy group), respectively, as described in JP-A No. 6-100642.

The above-mentioned copolymers (2) are preferably those which contain 2 to 3,000 pigment-philic groups per one molecule. If the number of the groups is less than 2, the dispersion stability is insufficient and if it exceeds 3,000, the viscosity becomes so high as to make handling difficult and also the particle size distribution of the colloidal particles becomes wide and the chromaticity is decreased. It is more preferably 25 to 1500.

The above-mentioned copolymers (2) preferably have a number average molecular weight of 2,000 to 1,000,000. If it is less than 2,000, the dispersion stability is insufficient and if it exceeds 1,000,000, the viscosity becomes so high as to make handling difficult and also the particle size distribution of the colloidal particles becomes wide and the chromaticity is decreased. It is more preferably 4,000 to 500,000.

The straight chain polymers (3) having pigment-philic portions comprising a pigment-philic group in one terminal of the main chain comprise pigment-philic portions comprising one or a plurality of pigment-philic groups in only one terminal of the main chain, but have sufficiently high affinity to the pigment surface.

The straight chain polymers (3) are not particularly limited and examples of the polymers (3) are A-B block type polymers in which one block is basic as described in JP-A No. 46-7294; A-B block type polymers in which aromatic carboxylic acid is introduced into the A block as described in U.S. Pat. No. 4,656,226; A-B block type polymers in which one terminal is terminated with basic functional group as described in U.S. Pat. No. 4,032,698; A-B block type polymers in which one terminal is terminated with acidic functional group as described in U.S. Pat. No. 4,070,388; and polymers with improved weathering yellowing resistance as described in JP-A No. 1-204914, derived from A-B block type polymers in which aromatic carboxylic acid is introduced into the A block as described in U.S. Pat. No. 4,656,226.

The above-mentioned straight chain polymers (3) are preferably those having 2 to 3,000 pigment-philic groups per one molecule. If the number of the groups is less than 2, the dispersion stability is insufficient and if it exceeds 3,000, the viscosity becomes so high as to make handling difficult and also the particle size distribution of the colloidal particles becomes wide and the chromaticity is decreased. It is more preferably 5 to 1500.

The above-mentioned straight chain polymers (3) preferably have a number average molecular weight of 1,000 to 1,000,000. If it is less than 1,000, the dispersion stability is insufficient and if it exceeds 1,000,000, the viscosity becomes so high as to make handling difficult and also the particle size distribution of the colloidal particles becomes wide and the chromaticity is decreased. It is more preferably 2,000 to 500,000.

As the high molecular weight pigment dispersant, commercialized ones may also be used. Examples of the commercialized ones are Solsperse 20000, Solsperse 24000, Solsperse 26000, Solsperse 27000, and Solsperse 28000 (manufactured by Zeneca K.K.); Disperbyk 160, Disperbyk 161, Disperbyk 162, Disperbyk 163, Disperbyk 166, Disperbyk 170, Disperbyk 180, Disperbyk 182, Disperbyk 184, and Disperbyk 190 (manufactured by Byk Mallinckrodt International Corporation,); EFKA-46, EFKA-47, EFKA-48, and EFKA-49 (manufactured by EFKA Chemical Corp.); Polymer 100, Polymer 120, Polymer 150, Polymer 400, Polymer 401, Polymer 402, Polymer 403, Polymer 450, Polymer 451, Polymer 452, and Polymer 453 (manufactured by EFKA Chemical Corp.); Ajisper PB 711, Ajisper PA 111, Ajisper PB 811, and Ajisper PW 911 (manufactured by Ajinomoto Co,. Inc.), and Flowlen DOPA-158, Flowlen DOPA-22, Flowlen DOPA-17, Flowlen TG-730W, Flowlen G-700, and Flowlen TG-720W (manufactured by Kyoeisha Chemical Co., Ltd.).

The above-mentioned high molecular weight pigment dispersant is those which comprise pigment-philic groups in the side chains and side chains composing the solvation portions and have graft structures [the above-mentioned comb-teeth structure polymers (1)]; and those having the pigment-philic groups in the main chains [the above-mentioned copolymers (2) and straight chain polymers (3)], so that the dispersant can give good dispersibility of the colloidal particles and is suitable for protection colloid to metal colloidal particles. Use of the above-mentioned high molecular weight pigment dispersant gives a metal colloidal particle dispersion liquid containing metal colloidal particles in a high concentration.

In the invention, the above-mentioned high molecular weight pigment dispersant preferably has a softening point of 30° C. or higher. If it is lower than 30° C., the obtained metal solid sol may possibly cause blocking during storage. It is more preferably 40° C.

The content of the high molecular weight pigment dispersant is preferably 20 to 1,000 parts by weight based on 100 parts by weight of the above-mentioned metal. If it is less than 20 parts by weight, the dispersibility of the metal colloidal particles becomes insufficient and if it exceeds 1,000 parts by weight, in the case of mixing with a coating material or a resin molding product, the mixed amount of the high molecular weight pigment dispersant relative to the binder resin is so large as to cause adverse effects on physical properties. It is more preferably 50 to 650 parts by weight.

The size of a light-modulating unit cell in the invention is closely related with the resolution of a display element. As the cell is smaller, a display element with higher resolution can be produced. The size is generally 10 μm to 1 mm.

(Display Element)

Hereinafter, the display element of the invention will be described with reference to the drawings. The same reference numbers are assigned to members having similar functions in all the drawings and description thereof is omitted.

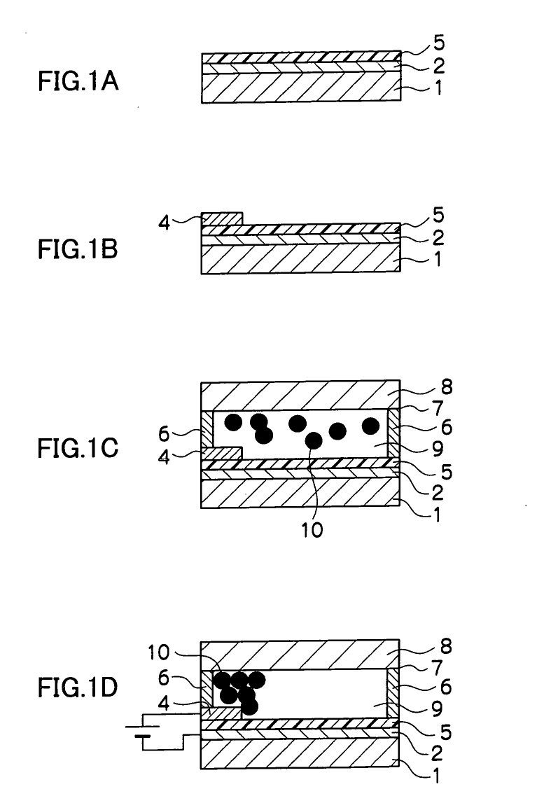

FIGS. 1A to 1D are schematic diagrams showing one example of the display element of the invention and the production process for the element.

The display element shown in FIG. 1C comprises a first electrode 2 disposed on the entire surface of a first substrate 1, an insulating layer 5 disposed thereon, a line-like second electrode 4 and a partitioning wall 6 disposed at one side of the first substrate 1, another partitioning wall 6 at the opposite side to the former partitioning wall 6, and a second substrate 8 opposite to the first substrate 1, to compose one cell. That is, the first and the second electrodes are laminated on one side of the substrate at horizontally and vertically different positions with respect to the substrate face, and the second electrode has a region overlapping the first electrode in the horizontal direction

A dispersion liquid containing transportable charged fine particles 10 and an insulating liquid 9 is sealed in the cell. The joint faces of the partitioning wall 6 and the second substrate 8 are bonded with a thermally fusible adhesion layer 7. Partitioning walls (not illustrated) of other cells exist at the near side and the far side of FIG. 1C.

FIG. 1D is a schematic structural view of a display element provided with a voltage applicator to enable application of voltage (FIG. 1C+voltage applicator).

Hereinafter, the operation of the display element of the invention will be described with reference to FIGS. 1C and 1D.

When no voltage is applied, as shown in FIG. 1C, the transportable charged fine particles 10 are evenly dispersed and the color of the particles 10 is observed as the cell color (e.g. red color). On the other hand, when voltage is applied, the transportable charged fine particles 10 bearing negative charge are transported to the positive electrode (the second electrode 4) side, so that the color of the first substrate (e.g. white color) appears via a transparent electrode and the display element is seen to be white.

The transportation of the transportable charged fine particles 10 is parallel to the faces of the substrates 1 and 8 at the time of voltage application.

Preferable examples of the substrates 1, 8 are films and plate-like substrates of polymers such as polyesters (e.g. polyethylene terephthalate), polyimides, polymethyl methacrylate, polystyrene, polypropylene, polyethylene, polyamides, nylon, polyvinyl chloride, polyvinylidene chloride, polycarbonates, polyether sulfone, silicone resins, polyacetal resins, fluoro resins, cellulose derivatives, and polyolefins; and inorganic substrates such as glass substrates, metal substrates, and ceramic substrates, and at least one of the substrates is preferably light transmissive. When using the element as a transmission type optical element, substrates having at least 50% light transmissivity are preferably used.

As the material to be used for the first and second electrodes 2, 4, layers of metal oxides such as tin oxide-indium oxide (ITO), tin oxide, and zinc oxide are preferably used. Transparent electrodes having at least 50% light transmissivity are preferably used. In the case of use for reflection type optical elements, as the electrode material to be used for the electrode 2 at the far side in the viewing direction, besides the above-mentioned metal oxides such as tin oxide-indium oxide (ITO), tin oxide, and zinc oxide, conductive polymers, carbon layer and metal layers of copper, aluminum, gold, silver, nickel and platinum can be used.

As the materials for the first and second electrodes, these materials may be used alone or a plurality of them may be used in the form of layers.

If both electrodes 2, 4 are transparent electrodes, the element can be used also as a transmission type display element.

The thickness and the size of the first and second electrodes 2, 4 are not particularly limited and may vary in accordance to the display element.

The height of the partitioning walls 6 is not particularly limited and is generally about 2 μm to 1 mm.

The width of the partitioning walls 6 is not particularly limited and generally the smaller the width, the more advantageous in terms of the resolution of the display element and in general, the width is about 1 μm to 1 mm.

The material for the adhesion layer 7 is not particularly limited and thermosetting resins and UV-curable resins may be used and materials which do not affect the materials constituting the display element, e.g. the materials of the partitioning walls and the insulating liquid, are selected.

The material for the insulating layer 5 is not particularly limited and conventionally known insulating materials can be used and, for example, acrylic resins, polyimide resins, and amorphous fluoro resins can be used.

The material for the partitioning walls 6 is not particularly limited and conventionally known photosensitive resins can be used.

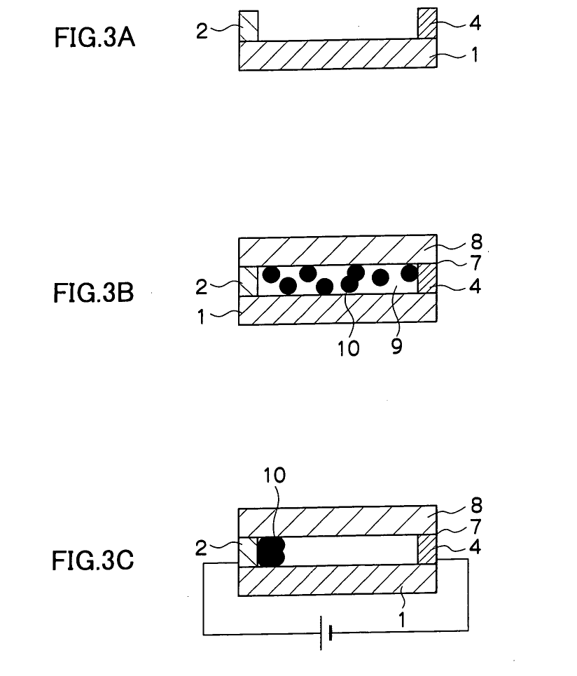

As shown in FIGS. 3A to 3C, which will be described later, when electrodes having a function as a partitioning wall are used, the material for the partitioning walls is the same as for the electrode material.

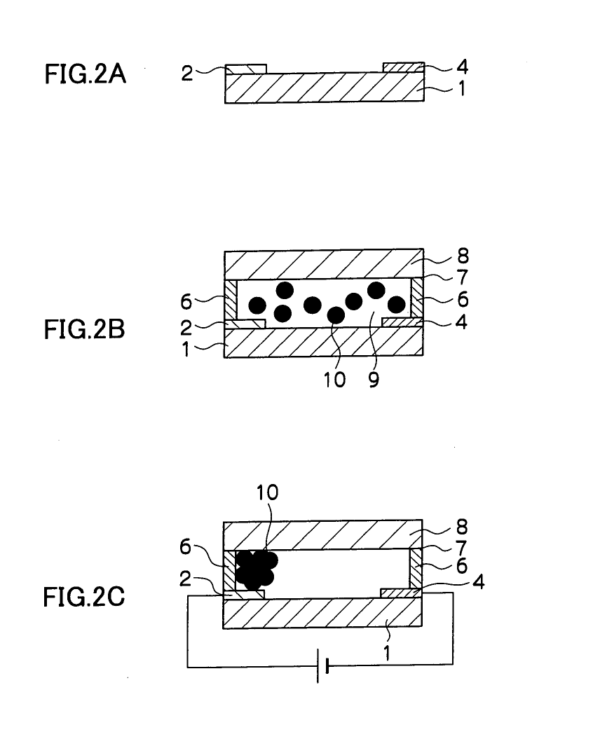

Next, the display element of FIG. 2B will be described.

The display element of FIG. 2B comprises the first electrode 2 and the second electrode 4 formed linearly at both sides of a first substrate 1, that is, the electrodes are arranged parallel to the substrate face. Partitioning walls 6 are formed on the respective electrodes and a second substrate 8 is formed opposite to the first substrate 1 to form one cell. Further, in FIG. 2C, a voltage applicator for both electrodes is installed.

A dispersion liquid containing transportable charged fine particles 10 and an insulating liquid 9 is sealed in the cell.

The line width of both electrodes is not particularly limited and is generally about 2 μm to 1 mm.

The thickness of both electrodes is not particularly limited and is generally about 10 nm to 5 μm.

The height of the partitioning walls 6 is not particularly limited and is generally about 2 μm to 1 mm.

The width of the partitioning walls 6 is not particularly limited and is generally about 1 μm to 1 mm.

Partitioning walls (not illustrated) of other cells exist at the near side and the far side in FIG. 2B.

The operation of the display element shown in FIG. 2B is similar to that described for the display element shown in FIG. 1C.

The display element of FIG. 3B comprises the first electrode 2 and the second electrode 4 formed linearly at both sides of a first substrate 1 and, further, a second substrate 8 is arranged opposite to the first substrate 1 to form one cell. A dispersion liquid containing transportable charged fine particles 10 and an insulating liquid 9 is sealed in the cell. The joint faces of both electrodes 2, 4 having the function of partitioning walls and the second substrate 8, are bonded with a thermally fusible adhesion layer 7. Partitioning walls (not illustrated) of other cells exist at the near side and the far side of FIG. 3B.

The line width of both electrodes 2, 4 is not particularly limited and is generally about 1 μm to 1 mm.

The height of both electrodes 2, 4 is not particularly limited and is generally about 2 μm to 1 mm.

The operation of the display element shown in FIGS. 3A to 3C is similar to that of the display element shown in FIGS. 1A to 1D.

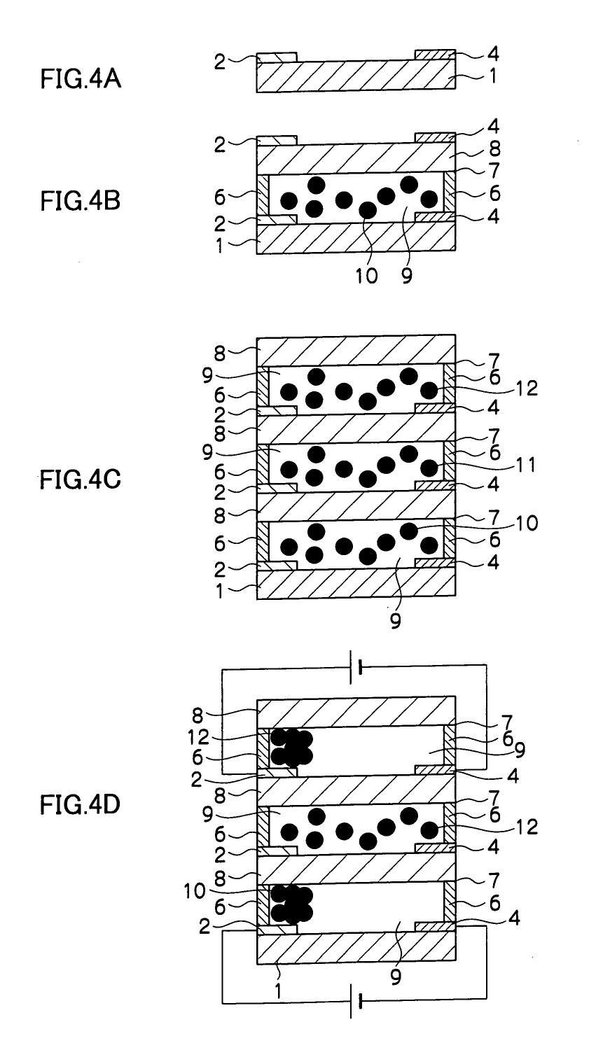

The display element shown in FIG. 4C has three-layer structure composed by vertically layering three cells of the kind shown in FIG. 2B. That is, a plurality of light-modulating unit cells (light-modulating layers) are layered while the light-modulating faces are overlaid on one another.

A red (R) light-modulating unit cell of the lowermost layer is formed in the same manner as shown in FIG. 2B and successively a green (G) light-modulating unit cell of the middle layer is formed, and finally a blue (B) light-modulating unit cell of the uppermost layer is formed to give a color display element having a layered structure.

Further, as another production method, RGB light-modulating unit cells are separately produced and the cells are joined to form a layered structure and give a color display element.

The materials to be used for the substrates 1, 8, the electrodes 2, 4, and the partitioning walls 6 and the respective sizes thereof are similar to those of the element shown in FIG. 2B.

The layered color display element of the invention works as shown in FIG. 4D when 40V voltage is applied to the electrodes in the first layer and the third layer.

At first, since the dispersed particles bear negative charge, the particles are seen to move to the positive electrode side due to the DC voltage application. Consequently, the particles in the first and the third layers move to the positive electrode side and only the particles in the second layer remain in a dispersed state and consequently, when the element is observed from the top side of the element, the color (green) of the particles in the second layer can be observed.

When voltage is applied to the first layer and the second layer in the same manner, the color (blue) of the particles in the third layer can be observed and when voltage is applied to the second layer and the third layer in the same manner, the color (red) of the particles in the first layer can be observed. Full-color display can be observed by controlling the voltage application to these three layers.

With respect to the display element of the invention, in accordance with the applications, wiring, a thin film transistor, a diode having metal-insulating layer-metal structure, a variable capacitor, a ferroelectric switching element for operation may be formed on the substrate.

### EXAMPLES

Hereinafter, the present invention will be described with reference to Examples in more detail. However it is not intended that the invention be limited to the illustrated Examples.

### Example 1

One example of a display element of the invention will be described along with FIGS. 1A to 1D.

At first, as a first electrode 2, ITO layer is formed to be of 50 nm thickness by sputtering method on a first substrate made of a 200 μm polyethylene terephthalate (PET) and is patterned in line-like state (line width: 300 μm). Next, an acrylic resin layer (thickness: 0.1 μm) as an insulating layer 5 is formed (refer to FIG. 1A).

Next, as a second electrode 4, aluminum layer is formed to be of 50 nm thickness by vacuum evaporation method and is subjected to line patterning by photolithographic method and dry etching method. The line width is about 30 μm (refer to FIG. 1B).

Successively, layers for partitioning walls are formed using a photosensitive polyimide varnish, exposed and etched by wet etching to form partitioning walls 6 with a height of 50 μm and a width of 20 μm.

After the thermally fusible adhesion layer 7 is formed on the joint faces of the partitioning walls 6 and the second substrate 8, water 9 containing gold colloidal particles 10 (Fine Sphere Gold, manufactured by Nippon Paint Co., Ltd., volume average particle diameter 20 nm) is filled between the walls 6 and then the second substrate 8 made of PET is heated to join the joint faces and produce a display element (refer to FIG. 1C). In this case, since the particles (metal colloidal particles) 10 show red in dispersed state, when the display element is viewed from the topside, the display element can be seen to be red.

Using the display element thus prepared, 80V voltage is applied to both electrodes such that the second electrode is positive. Since the dispersed particles bear negative charge, the particles are seen moving to the positive electrode side due to voltage application. Accordingly, in the case the first electrode is set to be negative and the second electrode is set to be positive, the particles move to the second electrode side and through the transparent first electrode, the white first substrate appears and the display element is observed to be white. When AC voltage is applied to the electrodes of the element showing white, the particles return to the dispersed state and show red.

### Example 2

One example of the display element of the invention will be described along with FIGS. 2A to 2C.

At first, ITO layer is formed to be of 50 nm thickness by sputtering method on a first substrate made of a 200 μm polyethylene terephthalate (PET) and patterned in line-like state to form the first electrode 2 and the second electrode 4. The line width is about 30 μm (refer to FIG. 2A).

Next, layers for partitioning walls are formed using a photosensitive polyimide varnish, exposed and etched by wet etching to form partitioning walls 6 with a height of 50 μm and a width of 20 μm.

After the thermally fusible adhesion layer 7 is formed on the joint faces of the partitioning walls 6 and the second substrate 8, water 9 containing gold colloidal particles 10 (Fine Sphere Gold, manufactured by Nippon Paint Co., Ltd., volume average particle diameter 20 nm) is filled between the walls 6 and then the second substrate 8 made of PET is heated to join the joint faces and produce a display element (refer to FIG. 2B).

In this case, since the particles (metal colloidal particles) 10 show red in dispersed state, when the display element is observed from the topside, the display element can be seen to be red. Using the display element thus produced, 40V voltage is applied to both electrodes such that the first electrode is positive. Since the dispersed particles bear negative charge, the particles are seen moving to the positive electrode side due to voltage application. Accordingly, in the case the first electrode is set to be positive and the second electrode is set to be negative, the particles move to the first electrode side and through the transparent insulating solvent, the white first substrate appears and the display element is observed to be white. When AC voltage is applied to the electrodes of the element showing white, the particles return to the dispersed state and show red.

### Example 3

One example of the display element of the invention will be described along with FIGS. 3A to 3C.

After a gold film with 50 μm thickness is formed by plating on a first substrate 1 (a 700 μm-thick glass substrate), the gold film is patterned in line-like state to form the first electrode 2 and the second electrode 4, which have a function as a partitioning wall. The line width is about 10 μm (refer to FIG. 3A).

Next, after the thermally fusible adhesion layer 7 is formed on the joint faces of the partitioning walls (both the electrodes 2, 4) and the second substrate, water dispersion liquid containing gold colloidal particles 10 is filled between the partitioning walls and then the second substrate 8 made of PET is heated to join the joint faces and produce a display element (refer to FIG. 3B). In this case, since the particles show red in dispersed state, the display element can be seen to be red.

Using the display element thus produced, 40V voltage is applied to both electrodes 2, 4 such that the first electrode is positive. Since the dispersed particles bear negative charge, the particles are seen moving to the positive electrode side due to voltage application. Accordingly, in the case the first electrode is set to be positive and the second electrode is set to be negative, the particles move to the first electrode side and through the transparent insulating solvent, the white first substrate appears and the display element is observed to be white. When AC voltage is applied to the electrodes of the element showing white, the particles return to the dispersed state and show red.

### Example 4

A display element is produced in the same manner as Example 3, except that gelatin is used in place of water in Example 3. After dissolved in water, gelatin is mixed and stirred with gold colloidal particles to obtain gelatin containing gold colloidal particles, and the gelatin is then applied by ink-jet method to the inside of a cell surrounded with partitioning walls.

Similarly to the case of Example 3, particles are seen moving by voltage application. When AC voltage is applied to the electrodes of the element showing white, the particles return to the dispersed state and show red.

### Example 5

One example of the display element of the invention will be described along with FIGS. 4A to 4D.

At first, ITO layer is formed to be of 50 nm thickness by sputtering method on a first substrate made of a 200 μm polyethylene terephthalate (PET) and is patterned in line-like state to form the first electrode 2 and the second electrode 4. The line width is about 30 μm (refer to FIG. 4A).

Next, layers for partitioning walls are formed using a photosensitive polyimide varnish, exposed and etched by wet etching to form partitioning walls 6 with a height of 50 μm and a width of 20 μm.

After the thermally fusible adhesion layer 7 is formed on the joint faces of the partitioning walls 6 and the second substrate 8, water 9 containing gold colloidal particles 10 (red: Fine Sphere Gold, manufactured by Nippon Paint Co., Ltd., volume average particle diameter 20 nm) is filled into the cell surrounded with the partitioning walls 6 and then the second substrate 8 made of PET and bearing a ITO film is heated to join the joint faces and produce a red light-modulating unit cell having dispersed gold colloidal particles (red) (refer to FIG. 4B).

Successively, green and blue light-modulating unit cells are formed on the second substrate 8 of the above-mentioned red light-modulating unit cell according to the following procedure.

A green light-modulating unit cell is formed on the second substrate 8 of the red light-modulating unit cell by the same method as used for producing the red light-modulating unit cell except that gold colloidal particles (green) (300 nm) are used in place of the gold colloidal particles (red).

Further, a blue light-modulating unit cell is formed on the second substrate 8 of the green light-modulating unit cell formed on the red light-modulating unit cell by the same method as used for producing the red light-modulating unit cell except that a second substrate 8 having no ITO film is used in place of the second substrate bearing the ITO film and that gold colloidal particles (blue) (50 nm) are used in place of the gold colloidal particles (red).

As a result, a display element having a layered structure composed of respective layers (light-modulating unit cells) with RGB 3 colors is obtained.

Using the display element thus produced, 40V voltage is applied to the electrodes of the first and third layers. Since the dispersed particles bear negative charge, the particles are seen moving to the positive electrode side due to voltage application. Accordingly, the particles in the first and third layers move to the positive electrode sides and only the particles in the second layer remain in dispersed state and as a result, the particle color (green) of the second layer is observed when the element is observed from the top side.

What is claimed is:

1. A display element comprising a first electrode, a second electrode, and a light-modulating layer containing transportable charged fine particles showing coloration in a dispersion state.

2. The display element of claim 1 comprising a pair of parallel substrates sandwiching the electrodes and the light-modulating layer, wherein display is switched by movement of the transportable charged fine particles in direction parallel to a face of the substrates.

3. The display element of claim 2, wherein the electrodes are parallel to each other on the light-modulating layer side of one of the substrates.

4. The display element of claim 2, wherein the electrodes are layered over each other on the light-modulating layer side of one of the substrates and are positioned differently from each other in the horizontal and vertical directions, and one of the electrodes has a region overlapping the other electrode in the horizontal direction.

5. The display element of claim 1, wherein the transportable charged fine particles are dispersed in an insulating liquid.

6. The display element of claim 1, wherein the transportable charged fine particles are dispersed in a polymer resin.

7. The display element of claim 1, wherein the transportable charged fine particles are metal colloidal particles having a plasmon-coloration function.

8. The display element of claim 7, wherein the metal colloidal particles are of gold or silver.

9. The display element of claim 1, wherein the transportable charged fine particles have a volume average particle diameter of 1 to 100 nm.

10. The display element of claim 1, further comprising a voltage applicator to apply voltage to the electrodes.

11. A display element comprising a plurality of light-modulating unit cells, the unit cells each comprising a first electrode, a second electrode, and a light-modulating layer containing transportable charged fine particles showing coloration in a dispersion state, wherein the unit cells are layered such that light-modulating faces of the light-modulating layers are overlaid on each other.

12. The display element of claim 11 comprising a pair of parallel substrates sandwiching the electrodes and the light-modulating layer, wherein display is switched by movement of the transportable charged fine particles in direction parallel to a face of the substrates.

13. The display element of claim 12, wherein the electrodes are parallel to each other on the light-modulating layer side of one of the substrates.

14. The display element of claim 12, wherein the electrodes are layered over each other on the light-modulating layer side of one of the substrates and are positioned differently from each other in the horizontal and vertical directions, and one of the electrodes has a region overlapping the other electrode in the horizontal direction.

15. The display element of claim 11, wherein the transportable charged fine particles are dispersed in an insulating liquid.

16. The display element of claim 11, wherein the transportable charged fine particles are dispersed in a polymer resin.

17. The display element of claim 11, wherein the transportable charged fine particles are metal colloidal particles having a plasmon-coloration function.

18. The display element of claim 17, wherein the metal colloidal particles are of gold or silver.

19. The display element of claim 11, wherein the transportable charged fine particles have a volume average particle diameter of 1 to 100 nm.

20. The display element of claim 11, further comprising a voltage applicator to apply voltage to the electrodes.
